(19) United States
(12) Patent Application Publication
(10) Pub. No.: US 2026/0083114 A1
(43) Pub. Date: Mar. 26, 2026

(54) A MODULAR AGRICULTURAL TREATMENT SYSTEM AND A METHOD FOR OPERATING A MODULAR AGRICULTURAL TREATMENT SYSTEM

(71) Applicant: BASF SE, Ludwigshafen am Rhein (DE)

(72) Inventors: Horst Dieter BRIX, Limburgerhof (DE); Michael KRAPP, Limburgerhof (DE); Christian POPP, Limburgerhof (DE); Anja SIMON, Limburgerhof (DE); Tobias SCHWABEN, Limburgerhof (DE)

(21) Appl. No.: 19/109,074

(22) PCT Filed: Sep. 5, 2023
(86) PCT No.: PCT/EP2023/074267

§ 371 Date: Mar. 5, 2025

(30) Foreign Application Priority Data
Sep. 5, 2022 (EP) 22193883.0

(51) Int. Cl. A01M 7/00

(52) U.S. Cl. CPC A01M 7/0092; A01M 7/0042

(57) ABSTRACT

The invention relates to a method for operating a modular agricultural treatment system comprising a base station and at least one field device. The base station has at least three base containers, to be filled with base products. Each field device comprises at least two field containers, to be filled with field products. According to the method, base product data and field data are provided. Based on the base product data and the field data base products and/or mixtures of base products to be used as the field products are determined. The base products are filled into the field containers of the field device accordingly. Further, for each of a plurality of zones of the agricultural field, a product composition made up out of the field products is determined. The field products are applied to the zones of the agricultural field by the field device according to the determined product composition. The invention further relates to a corresponding modular agricultural treatment system

### FIELD OF THE INVENTION

The present invention relates to digital farming. In particular, the present invention relates to a method for operating a modular agricultural treatment system that is useable for treating a harmful organism and/or a plant health deficiency on an agricultural field. The present invention further relates to a modular agricultural treatment system.

### BACKGROUND OF THE INVENTION

Farmers often lack sufficient work force to execute cropping related activities at the best moment in a season. Decisions that are triggered by digital systems based on forecast (e.g. weather), monitoring (e.g., of pest or diseases) and agronomic knowledge systems only give a relief to farmer's workload if the activity is executed by a smart system acting autonomously. Such systems increase the timeliness and spatial accuracy of an application of products. By defining treated versus non-treated areas within the field and adapting a choice and rate of product(s), a desirable effect on target and a saving of input of product(s) is realized. Due to the autonomous character of the application system, a number of spray events is no longer a bottleneck to the farmer. However, the number of potential product choices is limited and does not fully reflect changing in-field conditions such as the biological target situation or the application conditions like, e.g., humidity, temperature or wind speed

### SUMMARY OF THE INVENTION

It is therefore an objective of the present invention to provide a method for operating a modular agricultural treatment system that provides an improved choice and application of products. It is a further objective of the present invention to provide a related modular agricultural treatment system.

The objective of the present invention is solved by the subject-matter of the independent claims, wherein further embodiments are incorporated in the dependent claims.

According to an aspect of the invention, a method for operating a modular agricultural treatment system that is useable for treating a harmful organism and/or a plant health deficiency on an agricultural field is provided.

At least a part of said method may be implemented on a computer. In this context, “computer” may refer to any computing device, e.g., a smartphone, tablet computer, a personal computer, a supercomputer or a computer part of a farm management program on a device. In particular, the method may be executed on a plurality of processors, parallelizing and therefore speeding up the execution of the method. Also, the method may be split on more than one computer, wherein the computers are connected to one another with a wireless and/or wired connection.

A “harmful organism” is understood to be any organism which has a negative impact to the growth or to the health of the agricultural crop plant. Further, “plant health deficiency” is any other condition that is adverse to the health of the plant, such as lack of water, lack of nutrients, lack of minerals or lack of growth regulators.

The term “agricultural field” is understood to be any area in which organisms, particularly crop plants, are produced, grown, sown, and/or planned to be produced, grown or sown. The term “agricultural field” also includes horticultural fields and silvicultural fields. The agricultural field may have open field conditions or may be in a protected area, e.g., a greenhouse. Preferred crops that are produced, grown and/or sown on the agricultural field are Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Latcuca sativa, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Raphanus sativus, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea mays. Most preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays. Especially preferred crops are crops of cereals, corn, soybeans, rice, oilseed rape, cotton, potatoes, peanuts or permanent crops.

The modular agricultural treatment system is in particular an autonomous system that requires little or no input from a user, e.g., from a farmer. The modular agricultural treatment system comprises a base station and at least one field device. The base station may be located or placed nearby the agricultural field such that the field device(s) do not have to travel needless ways. The base station comprises at least three base containers, wherein each of the base containers is filled with a base product. In particular, the base products in different base containers are different from one another. More particularly, a first base product in a first base container, a second base product in a second base container, and a third base product in a third base container are mutually different from one another. Preferably, the modular agricultural treatment system comprises a plurality of field devices such that the treatment of the agricultural field can be performed in a timely manner. Each field device comprises at least two field containers. In particular, the number of field containers of each field device may be less than the number of base containers. Each of the field containers is adapted to be filled with a field product, and the field device is adapted to apply the field products to the agricultural field. In particular, the field products may be sprayed by the field device onto the agricultural field.

According to the method, base product data relating to the base products is provided. The base products may, e.g., be labelled by product identifiers. The base product data may comprise active ingredient information, agricultural performance information, dosage form, viscosity, surface tension, turbidity, risk of phase separation, loading, physical compatibility data, chemical data, crop registration, health deficiency registration and/or mixture registration. Active ingredient information may be considered when the necessity of certain active ingredients has already been determined, e.g., by the detection of a certain harmful organism that needs to be treated with said certain active ingredient. The agricultural performance information is related to the active ingredient information: it includes the information that the product has a certain agricultural performance, e.g., the control of a certain pest. The dosage form may be, for example, a solution, a suspension, an emulsion or a solid product. Loading comprises information on how the product may be loaded on the treatment system, e.g., whether a tank needs to fulfil certain safety requirements. Crop registration comprises information on whether the product is registered to be used on a certain crop, maybe in dependence on the date or on a growth stage of the crop. Health deficiency registration comprises information on whether the product is registered to be used to treat a certain health deficiency. The crop registration and/or health deficiency registration may also include information on a maximum amount of a product that is registered to be used on a certain crop and/or to treat a certain health deficiency. Mixture registration comprises information on whether the product is registered to be mixed with other products.

Further, field data relating to field conditions on the agricultural field is provided. Then, base products and/or mixtures of base products to be used as the field products are determined based on the base product data and the field data. The determination of said base products and/or mixtures of base products is such that mixtures of the field products can be made that are optimal for the agricultural field, e.g., to treat a harmful organism and/or a plant health deficiency. The determination of the base products and/or mixtures of the base products to be used as the field products may be further made such that the intended mixtures of the field products comply with regulatory and/or legal requirements and may be made considering relevant agronomic and/or regulatory practice thresholds.

Then, the base products are filled into the field containers of the field device such that the field products in the field containers are the determined field products. If the field products are determined to be pure, i.e., unmixed, base products, the respective base products are filled into the field containers. If, on the other hand, the field products are mixtures of base products, the base products may be mixed in the base station and the mixture of the base products may then be filled into the respective field containers. Said mixing in the base station may be performed using one or more mixing chambers and adjusting the flow of the base products to the mixing chamber(s) accordingly. Alternatively, or additionally, the mixing may be performed by adding the base products to a dedicated mixing tank, where the base products may also be stirred. Alternatively, or additionally, the base products may be separately filled into the field containers, wherein the amounts of each of the base products that is filled into a field container is chosen according to the determined mixture of base products. The field containers may comprise means to stir the base products, or the base products may be mixed well enough by filling them into the field containers and/or shaking the field containers, e.g., due to the movement of the field device. As yet another alternative, the two above options may be combined, such that some of the base products are mixed in the base station and then filled into the field containers and the other base products are directly added to the field containers. Naturally, it is also possible that some of the field products are pure base products whereas the other field products are mixtures of base products.

The base station may issue an alert or a notification to a user, e.g., a farmer, when one or more of the base containers need to be refilled with the base products and/or when such a refill is expected to be required within a predetermined time span. The user may then refill the base products before they run out. Alternatively, or additionally, the base station may be connected to a reloading unit and/or to an automatic ordering system and may transmit a refill order when one or more of the base containers need to be refilled with the base products and/or when such a refill is expected to be required within the predetermined time span. The need for a refill may be determined by a gauge that measures the remaining base products in each base container, wherein the need for a refill is indicated when the remaining amount falls below a predetermined value. Alternatively, or additionally, the need for a refill may be determined based on the recorded usage of the base products and/or a predicted need of the base products to treat the agricultural field.

Further, for each of a plurality of zones of the agricultural field, a product composition made up out of the field products to be applied to the zone of the agricultural field is determined. Said determination is based on the base product data and the field data. It is made, in particular, such that the product composition is optimal for the zone of the agricultural field, e.g., to treat a harmful organism and/or a plant health deficiency. The determination may be further made such that the product composition complies with regulatory and/or legal requirements and may be made considering relevant agronomic and/or regulatory practice thresholds. In this context, the term “zone” is understood to be a sub-field zone or a part of the agricultural field, i.e., the agricultural field can be spatially divided into more than one zone, wherein each zone may have different properties. Further, the “product composition” may be a mixture of field products but may also be only one of the field products. In addition to the product composition, a rate of said product composition to be applied to the zones of the agricultural field may be determined, e.g., given as a volume of the product composition to be applied per unit area.

Finally, the field products are applied to the zones of the agricultural field by the field device according to the determined product composition. Said application of the field products may be performed with a direct injection system. Different droplet sizes may be achieved, e.g., by using different spray nozzles, a different spray pressure and/or a flexible use of droplet size modulating products. Also, a different application rate may be achieved, e.g., by varying a speed of the field device, by using different spray nozzles and/or by using a different spray pressure.

Hence, an optimal mixture of the base products is applied to zones the agricultural field, wherein “optimal” may be a holistical response to all relevant conditions of the agricultural field. This may ensure an optimal input-output ratio, wherein the input refers particularly to the base products used and the output refers to the agricultural effect, an increase in profitability and an avoidance of excessive use of products, without having to (re-)formulate existing products under changing conditions.

According to an embodiment, the base products are at least one out of a group or a mixture of at least two out of the group, the group consisting of chemical products, biological products, fertilizers, nutrients, bio-stimulants, pheromones, water, tank-mix adjuvants, detergents, compatibilizers, anti-foaming agents, water conditioners and pH-modifiers. Here, the chemical products and biological products may be crop protection compounds. Water or other suitable liquids may be used as a solvent, i.e., as a carrier for other base products.

In particular, the base products may be solo products, may be pre-mixes of products or may be all-in-one combinations of several products. In particular, the base products may be provided as liquids or as solids. The chemical products may be fungicides, herbicides, insecticides, acaricides, molluscicides, nematicides, avicides, piscicides, rodenticides, repellants, pheromones, bactericides, biocides, safeners, plant growth regulators, urease inhibitors, nitrification inhibitors or denitrification inhibitors. The biological products may be microorganisms acting as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, pheromone, bactericide, biocide, safener, plant growth regulator, urease inhibitor, nitrification inhibitor or denitrification inhibitor. Tank-mix adjuvants may be products that amongst other functionalities such as increasing bio-performance of the products also act as compatibilizers preventing the phase separation in a tank or that ease the mixing compatibility of other products and are particularly used when the product is a mixture. Compatibilizers may be used in a mixture or alone and ease the mixture of other products or modify the mixture of other products such that the mixture achieves certain properties, such as sprayability, reduced surface tension or adjusted droplet size distribution.

In a preferred embodiment of the present invention, at least one of the products is an herbicide from at least one of the following classes: acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl (thio) benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

In another preferred embodiment of the present invention, at least one of the products is an herbicide selected from herbicides of class b1) to b15):
b1) lipid biosynthesis inhibitors;
b2) acetolactate synthase inhibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitosis inhibitors;
b10) inhibitors of the synthesis of very long chain fatty acids (VLCFA inhibitors);
b11) cellulose biosynthesis inhibitors;
b12) decoupler herbicides;
b13) auxinic herbicides;
b14) auxin transport inhibitors; and
b15) other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, triaziflam, tridiphane; including their agriculturally acceptable salts, amides, esters or thioesters.

In a preferred embodiment of the present invention, at least one of the products is one of the following herbicides or herbicide mixtures: As examples, products that provide an inhibition of Acetyl CoA Carboxylase are Cyclohexanediones (DIMs), Aryloxyphenoxypropionates (FOPs) and/or Phenylpyrazoline, products that provide an inhibition of Acetolactate Synthase are Pyrimidinyl benzoates, Sulfonanilides, Triazolopyrimidine, Sulfonylureas, Imidazolinones and/or Triazolinones, products that provide inhbition of Photosynthesis at PSII—Serine 264 Binders are Triazines, Triazolinone, Triazinones, Uracils, Phenlcarbamates, Pyridazinone, Ureas and/or Amides, products that provide inhbition of Photosynthesis at PSII—Histidine 215 Binders are Nitriles, Phenyl-pyridazines and/or Benzothiadiazinone, products that provide PS I Electron Diversion are Pyridiniums, products that provide inhibition of Protoporphyrinogen Oxidase are Diphenyl ethers, Phenylpyrazoles, N-Phenyl-oxadiazolones, N-Phenyl-triazolinones and/or N-Phenyl-imides, products that provide inhibition of Phytoene Desaturase are Phenyl ethers, N-Phenyl heterocycles and/or Diphenyl heterocycles, products that provide inhibition of Hydroxyphenyl Pyruvate Dioxygenase are Triketones, Pyrazoles and/or Isoxazoles, a product that provides inhibition of Homogentisate Solanesyltransferase is Phenoxypyridazine, a product that provides inhibition of Deoxy-D-Xylulose Phosphate Synthase is Isoxazolidinone, a product that provides inhibition of Enolpyruvyl Shikimate Phosphate Synthase is Glycine, products that provide inhibition of Glutamine Synthetase are Phosphinic acids, a product that provides inhibition of Dihydropteroate Synthase is Carbamate, products that provide inhibition of Microtubule Assembly are Dinitroanilines, Pyridines, Phosphoroamidates, Benzoic acid and/or Benzamides, products that provide inhibition of Microtubule Organization are Carbamates, products that provide inhibition of Cellulose Synthesis are Triazolocarboxamide, Benzamides, Alkylazines and/or Nitriles, products that act as uncouplers are Dinitrophenols, products that provide inhibition of Very Long-Chain Fatty Acid Synthesis are Azolyl-carboxamides, α-Thioacetamides, Isoxazolines, Oxiranes, α-Chloroacetamides, α-Oxyacetamides, Thiocarbamates and/or Benzofurans, products that act as Auxin Mimics are Pyridine-carboxylates, Pyridyloxy-carboxylates, Phenoxy-carboxylates, Benzoates, Quinoline-carboxylates, Pyrimidine-carboxylates and/or Phenyl carboxylates, products that act as Auxin Transport Inhibitor are Aryl-carboxylates, a product that provides inhibition of Fatty Acid Thioesterase is Benzyl ether, a product that provides inhibition of Solanesyl Diphosphate Synthase is Diphenyl ether, a product that provides inhibition of dihydroorotate dehydrogenase is Aryl pyrrolidinone anilide and a product that provides inhibition of Lycopene Cyclase is Triazole.

Examples for active ingredients in products are 2.4-D (choline, DMA, esters), Dicamba (BAPMA, DGA, Na, K), Florasulam, Acetochlor, Atrazine, Bentazone, Bicyclopyrone, Carfentrazone-E, Chlorimuron-E, Clethodim, Clomazone, Clopyralid, Cloransulam, DFFP, Diflufenican, Dimethenamid-P, Diquat, Flufenacet, Flumetsulam, Flumiclorac, Flumioxazin, Fluroxypyr, Fluthiacet, Fomesafen, Glufosinate-Ammonium, Glyphosate (K, IPA), Glyphosate-Potassium-Salt, Halauxifen, Halosulfuron, Haloxyfop-P-M, Imazamox, Imazethapyr, Isoxaflutole, Lactofen, Mesotrione, Metribuzin, Nicosulfuron, Paraquat, Pendimethalin, Pyroxasulfone, Quizalofop, Rimsulfuron, Saflufenacil, S-Metolachlor, Sulfentrazone, Tembotrione, Thifensulfuron, Tolpyralate, Topramezone, Tribenuron, Trifludimoxazin, Metazachlor, Quizalofop-P-E, Fenoxaprop, Chlortoluron, Glyphosate, Imazamox, Flurochloridone, MCPA, Flufenacet, Pinoxaden, Tribenuron-M, Diflufenican, Clomazone, Aclonifen, Fluroxypyr, Propaquizafop, Clethodim, Diquat and Florasulam. Examples of mixtures of active ingredients are L-Glufosinate Ammonium and DMTA-P; Dimethenamid-P and Topramezone; Flumioxazin and Pyroxasulfone; L-Glufosinate Ammonium and Topramezone; Glyphosate and Metolachlor; L-Glufosinate Ammonium and Mesotrione; Atrazine, Mesotrione and S-Metolachlor; Glyphosate and Saflufenacil; Atrazine and S-Metolachlor; Fluthiacet-M and Pyroxasulfone; L-Glufosinate Ammonium and Tembotrione; S-Metolachlor and Terbuthylazine; Dimethenamid-P and Saflufenacil; Benoxacor, Mesotrione and S-Metolachlor; Acetochlor and Fomesafen; GLY and GFA; L-Glufosinate Ammonium and Acetochlor; Atrazine and Mesotrione; L-Glufosinate Ammonium, Trifludimoxazin and Saflufenacil; Fomesafen and Glyphosate; 2.4-D-Choline and Glyphosate; Cyprosulfamide, Foramsulfuron, lodosulfuron-M-Na and Thiencarbazone-M; Dicamba, Nicosulfuron and Rimsulfuron; Acetochlor, Clopyralid and Mesotrione; Dicamba and Diflufenzopyr; Cyprosulfamide, Flufenacet, Foramsulfuron, Terbuthylazine and Thiencarbazone-M; Cyprosulfamide, Isoxaflutole and Thiencarbazone-M; Imazethapyr, Pyroxasulfone and Saflufenacil; Atrazine, Bicyclopyrone, Mesotrione and S-Metolachlor; GLY and Dicamba; Dicamba-Diglycolamine-Salt and S-Metolachlor; Glyphosate and Mesotrione; Mesotrione, S-Metolachlor and Terbuthylazine; Tembotrione and Thiencarbazone-M; Imazethapyr and Sulfentrazone; Isoxaflutole and Thiencarbazone-M; Glyphosate, Mesotrione and S-Metolachlor; Metribuzin and S-Metolachlor; Acetochlor and Atrazine; Acetochlor, Clopyralid and Flumetsulam; S-Metolachlor and Sulfentrazone; L-Glufosinate Ammonium and Saflufenacil; Bicyclopyrone, Mesotrione and S-Metolachlor; Imazethapyr and Saflufenacil; L-Glufosinate Ammonium and Trifludimoxazin; Mesotrione and Terbuthylazine; Mesotrione and Nicosulfuron; Dicamba Bapma Salt and L-Glufosinate Ammonium; L-Glufosinate Ammonium and Bicyclopyrone; Fomesafen and S-Metolachlor; Acetochlor and Mesotrione; 2,4-D Choline and L-Glufosinate Ammonium; Glyphosate, Saflufenacil and Fludimoxazin; Glyphosate-Isopropyl-Amine and Glyphosate-Potassium-Salt; Cloransulam-M and Sulfentrazone; Isoxadifen-E and Tembotrione; Flufenacet, Isoxadifen-E, Tembotrione and Terbuthylazine; Dimethenamid-P and Terbuthylazine; Dicamba and Tritosulfuron; Glufosinate, Pyroxasulfone and Imazamox; Saflufenacil and Trifludimoxazin; Glufosinate Ammonium and Acetochlor; Glufosinate Ammonium and S-Metolachlor; Glufosinate Ammonium and DMTA-P; Glufosinate Ammonium and Saflufenacil; Glufosinate Ammonium, Trifludimoxazin and Saflufenacil; 2,4-D Choline and Glufosinate Ammonium; GA and Pyroxasulfone; GA, Pyroxa and Imazamox; L-GA and DMTA-P; Pyroxasulfone and Saflufenacil; Pyroxasulfone and Picolinafen; Pyroxasulfone and Dimethenamid; Pyroxasulfone and Imazethapyr; Pyroxasulfone, Saflufenacil and Mesotrione; Dicamba, DFFP and Pyrox; Dicamba, Pyrox and Imazethapyr; Saflufenacil, Trifludimoxazin, Pyroxasulfone and Imazethapyr; Pyroxasulfon and Imazethapyr; Dicamba and DFFP; Dimethenamid-P, Metazachlor and Quinmerac; Cloquintocet-Mexyl, Florasulam and Pyroxsulam; Metazachlor and Quinmerac; Flufenacet and Pendimethalin; Imazamox and Imazapyr; Diflufenican, Flufenacet and Flurtamone; Florasulam and Pyroxsulam; Aminopyralid and Propyzamide; Metsulfuron-M and Tribenuron-M; 2.4-D and Florasulam; Diflufenican and Flufenacet; Florasulam and Tritosulfuron; Diflufenican, Florasulam and Penoxsulam; Chlortoluron and Diflufenican; lodosulfuron-M-Na and Mesosulfuron-M; lodosulfuron-M-Na, Mefenpyr-Diethyl and Mesosulfuron-M; Aminopyralid, Clopyralid and Picloram; as well as Thifensulfuron-M and Tribenuron-M.

In a preferred embodiment of the present invention, at least one of the products is at least one insecticide selected from the group consisting of: Triazemate, aldicarb, alanycarb, benfuracarb, carbaryl, carbofuran, carbosulfan, methiocarb, methomyl, oxamyl, primicarb, propoxur, thiodicarb, acephate, azinphos-ethyl, azinphos-methyl, chlorfenvinphos,, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos, trichlorfon, cyclodiene or-ganochlorine endosulfan, N-Ethyl-2,2-dimethylpropionamide-2-(2,6-dichloro-α.α.α-trifluoro-p-tolyl) hydrazon, N-Ethyl-2,2-dichloro-1 methylcyclopropane-carboxamide-2-(2,6-dichloro-a.a.a-trifluoro-p-tolyl) hydrazon, acetoprole, ethiprole, fipronil, pyrafluprole, pyriprole, vaniliprole, allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen, tralomethrin, nicotine, cartap, hydrochloride, thiocyclam, sulfoxaflor, acetamiprid, clothianidin, dinotefuran, imidacloprid, nitenpyram, thiacloprid, thiamethoxam, AKD-1022, spinosad, spinetoram, abamectin, emamectin, benzoate, lepimectin, milbemectin, hydroprene, kinoprene, fenoxycarb, pyriproxyfen, diafenthiuron, fenbutatin oxide, propargite, chlorfenapyr, buprofezin, bistrifluron, diflubenzuron, flufenoxuron, hexaflumuron, lufenuron, novaluron, teflubenzuron, cyromazine, methoxyfenozide, tebufenozide, azadirachtin, pyridaben, tolfenpyrad, flufenerim, indoxacarb, metaflumizone, tefluthrin, gamma-cyhalothrin, flupyradifurone, triflumezopyrim, afidopyropen, pymetrozine, flonicamid, spirotetramat, spidoxamat, dicloromezotiaz, chlorantraniliprole, cyantraniliprole, cyclaniliprole, tetraniliprole, flubendiamide, broflanilide, fluxametamide, dimpropyridaz, oxazosulfyl, fenmezoditiaz, isocycloseram.

In a preferred embodiment of the present invention, at least one of the products is at least one fungicide selected from the group consisting of:
mode of action group A (nucleic acids metabolism): phenylamides, hydroxy-(2-amino-)pyrimidines, heteroaromatics, carboxylic acids
mode of action group B (Cytoskeleton and motor protein): Methyl Benzimidazole Carbamates, N-phenyl carbamates, benzamides (toluamides), thiazole carboxamide, phenylureas, benzamides (pyridinylmethyl benzamides), cyanoacrylates, aryl-phenyl ketones
mode of action group C (respiration): pyrimidinamines, pyrazole-MET1, quinazoline, Succinate dehydrogenase inhibitors, QoI (Quinone outside Inhibitors) fungicides, QiI (Quinone inside Inhibitors) fungicides, dinitrophenyl crotonates, 2,6-dinitro-anilines, organo tin compounds, thiophene-carboxamides, QoSI fungicides (Quinone outside Inhibitor, stigmatellin binding type)
mode of action group D (protein synthesis): Anilino-Pyrimidines, enopyranuronic acid antibiotic, hexopyranosyl antibiotic, glucopyranosyl antibiotic, tetracycline antibiotic
mode of action group E (signal transduction): azanaphthalenes, phenylpyrolles, dicarboximides
mode of action group F (lipid synthesis or transport/membrane integrity or function): phosphor thiolates, Dithiolanes, aromatic hydrocarbons, 1,2,4-thiadiazoles, carbamates, Polyene, piperidinyl-thiazole-isoxazolines
mode of action group G (sterol biosynthesis in membrane): Demethylation Inhibitors (SBI: Class I), morpholines (SBI: Class II), KetoReductase Inhibitors (SBI: Class III), thiocarbamates (SBI Class IV), allylamines (SBI Class IV),
mode of action group H: cell wall biosynthesis: Polyoxins, Carboxylic Acid Amides
mode of action group I (melanin synthesis in cell wall): Melanin Biosynthesis Inhibitors—Reductase, Melanin Biosynthesis Inhibitors—Dehydratase, Melanin Biosynthesis Inhibitors—Polyketide synthase,
mode of action group P (host plant defence induction): benzo thiadiazole (BTH), benzisothiazole, thiadiazole carboxamide, polysaccharides, plant extracts, phosphonates, isothiazole
mode of action group U (Unknown mode of action): cyanoacetamide oxime, phthalamic acids, benzotriazines, benzene-sulfonamides, pyridazinones, phenylacetamide, guanidines, thiazolidine, pyrimidinone-hydrazones, 4-quinolyl-acetate, tetrazolyloxime, glucopyranosyl antibiotic
mode of action group M (Chemicals with multi-site activity): inorganic electrophiles, dithiocarbamates and relatives (eletrophiles), phthalimides (electrophiles), chloronitriles (phthalonitriles), sulfamides (electrophiles), bis-guanidines (membrane disruptors, detergents), triazines, quinones (anthraquinones) (electrophiles), quinoxalines (electrophiles), maleimide (electrophiles), thiocarbamate (electrophiles).

In a preferred embodiment of the present invention, at least one of the products is at least one fungicide selected from the group consisting of: Ametoctradin (Initium); Azoxystrobin; Boscalid; Carbendazim; Chlorothalonil; Copper; Copper; Cymoxanil; Difenoconazole; Dimethomorph; Dimoxystrobin; Dithianon; Dodemorph-acetate; Epoxiconazole; Fenpropimorph; Fludioxonil; Fluquinconazole; Fluxapyroxad (Xemium); Folpet; Folpet; Fosetyl-Al; Iprodione; KHP (Potassium Hydrogen Phosphonate); Kresoxim-methyl; Mancozeb; Metalaxyl; Metconazole; Metconazole; Metiram/other EBDCs (=Mancozeb, Maneb); Metrafenone; Metyltetraprole; Orysastrobin; Prochloraz; Propiconazole; Prothioconazole; Pyraclostrobin; Pyrimethanil; Revysol, Mefentrifluconazole; Silthiofam; Sulphur; Thiophanate-methyl; Thiophanate-methyl; Tricyclazole; Tridemorph; Triticonazole.

According to an embodiment, the base station is kept stationary while the field device applies the field products to the agricultural field. That is, the base station may be stationary during at least most of, in particular all of, the time during which the field products are applied to the agricultural field. In this context, “at least most of” may mean at least 75%, at least 90%, or at least 95%. The base station may be movable, e.g., in order to move it to a location where the base containers may be re-filled, to move it to a different agricultural field, or to move it to a more convenient location in or close to the agricultural field. However, as stated above, the base station will be stationary for most of the time during which the field products are applied to the agricultural field. Alternatively, the base station may be completely stationary.

According to an embodiment, the base station further performs supplying power to the field device. If the field device is electrically powered, this may encompass charging or reloading batteries. If the field device is fuel powered, this may encompass fueling the field device with the appropriate fuel, e.g., gas or hydrogen.

Additionally, or alternatively, the base station may further clean the field device. This may be performed on an on-demand basis or everytime that the field device is at the base station for filling the field container.

According to an embodiment, the field device is an agricultural robot. This may be a robot with wheels, with a chain-drive and/or with legs.

Alternatively, the field device is an unmanned aerial spraying system (UASS), i.e., a drone adapted for applying the field products to the agricultural field. This has the advantage that no damage is done to the crops.

According to another embodiment, the field devices may be heterogeneous, i.e., the modular agricultural treatment system may comprise different field devices, such as agricultural robots and UASSs. For example, the agricultural robots may apply the field product to large connected areas of the agricultural field whereas the UASSs may apply the field product to hard-to-reach parts of the agricultural field.

According to an embodiment, the field data comprises at least one out of a group, the group consisting of general field conditions, crop type, crop growth stage, crop disease, disease prediction, pest pressure, pest prediction, weed pressure, weed prediction, crop infection risk, abiotic stress, temperature, humidity, precipitation, weather conditions, weather forecast, soil characteristics, time of application, previously applied products and/or product requirements. Said field data may be provided for each of the zones of the agricultural field. The general field conditions, such as soil, geography, microclimate or soil moisture may be mapped before sowing. The crop type may be given by a crop identifier. The crop growth stage may be one out of germination, sprouting, bud development, leaf development, formation of side shoots, tillering, stem elongation or rosette growth, shoot development, development of harvestable vegetative plant parts, bolting, inflorescence emergence, heading, flowering, development of fruit, ripening or maturity of fruit and seed, senescence and beginning of dormancy, and may be provided on a BBCH scale. Further weather conditions may be, e.g. the wind speed and-direction. Soil characteristics may include the amount of minerals and/or nutrients in the soil. The time of application may be important, especially whether the application is performed during the day, i.e., with possible sunshine, or at night. The field data relating to previously applied products may have been recorded throughout the season, may even include data from past seasons and may be used to prevent infringement of product approvals and regulatory requirements (e.g, regarding buffer zones to sensitive areas or re-entry and pre-harvest intervals), to foster sustainability aspects and to perform (anti-) resistance management.

According to an embodiment, at least some of the field data is taken in short intervals, the short intervals being one week or less, preferably one day or less. Alternatively, or additionally, the field data is taken a short time span before applying the field products, the short time span being six hours or less, preferably two hours or less. The above applies, in particular, to rapidly changing field data such as crop growth stage, crop disease, pest pressure and/or weed pressure. Said field data may be obtained by drones, robots, planes, satellites and/or in-field sensors.

According to an embodiment, determining the base products and/or mixtures of base products to be used as the field products and/or determining the product compositions to be applied to the zones of the agricultural field is performed by a smart algorithm and/or an artificial intelligence system. Said smart algorithm may use, e.g., a knowledge system, which is, for example, based on big data. The artificial intelligence system may also be referred to as artificial intelligence decision support system. In particular, the systems may be self-learning systems that learn from previous actions that have been taken and the corresponding results. In particular, the determination of the base products and/or mixtures of base products to be used as the field products and the determination of the product compositions to be applied to the zones of the agricultural field may be performed together in order to take account of their interrelationship. The smart algorithm and/or the artificial intelligence system may also determine the need for a refill of the base containers with the base products based on the recorded usage of the base products and/or a predicted need of the base products to treat the agricultural field.

According to an embodiment, determining the product compositions to be applied to the zones of the agricultural field comprises generating an application map and applying the field products to the zones of the agricultural field according to the determined product composition comprises reading the determined product composition at the current location of the field device from the application map. In addition to the product composition to be applied to the zones of the agricultural field, the application map may include information on the rate at which said product composition is to be applied.

According to an embodiment, the field device obtains current field data during the application of the field product, and the product compositions to be applied to the zones of the agricultural field are determined based on said current field data. Further, the rate at which the product compositions are to be applied may also be determined based on the current field data. Hence, the application of the field products is tailored to the current situation of the agricultural field. The current field data may be collected by the field device using at least one sensor, e.g., a camera.

According to an embodiment, the determined product composition is achieved by mixing the field products, in particular with an on-board direct injection system of the field device. The mixing may be performed in one or several mixing chambers.

Alternatively, or additionally, the determined product composition is achieved by separately applying the field products, at rates corresponding to the determined product composition. That is, each field product may be applied by a separate spray nozzle.

A combination of the two options above may also be performed, i.e., some of the field products may be mixed in the field device and others may be applied by a separate spray nozzle.

According to an embodiment, the method further comprises obtaining a desired effect as user input and determining the base products and/or mixtures of base products to be used as the field products and/or determining the product compositions to be applied to the zones of the agricultural field is further based on the desired effect. The user may be, e.g., a farmer or another operator of the modular agricultural treatment system. The user input may be performed directly at the base station of the modular agricultural treatment system, e.g., via a user interface, or may be made remotely, e.g., using a smart device and/or a computer. The desired effect may be, e.g., a measure of level of investment and/or intensity for a desired outcome. Alternatively, or additionally, the desired effect may comprise a measure of quality of the crops, e.g., whether they are supposed to be used as animal food, as high-grade gourmet food, for seed production and/or for ethanol production.

Alternatively, or additionally, the desired effect may include an indication of a planned crop rotation, such that the agricultural field is treated already having the next season's crop in mind. With the desired effect as only user input, the farmer may not influence the modular agricultural treatment system directly, but the modular agricultural treatment system may be operated merely based on the desired effect that is input by the user and other rules such as agreed field management practices and/or regulatory requirements.

According to an embodiment, the method further comprises determining a time of application and the field products are applied to the agricultural field at the determined time of application. The time of application may depend, e.g., on changes in temperature, wind, humidity and/or crop sensitivity during the day. With the freedom of choosing the time of application, an application on demand is enabled for the agricultural field. The optimal timing of the application may also ensure achieving the best effect on target (e.g., relating to diseases, pests and/or weed). Further, due to the modular agricultural treatment system, the optimal time of application is not limited by the availability of work force. Also, it is possible to split the application of the products into two or more application instances, wherein for each of said instances, the optimal time of application is determined. Further, the time of application may be chosen differently for different zones of the agricultural field, depending on the field data associated with said zones.

According to an embodiment, when a field device is scheduled to treat a particular part of the agricultural field, specific base products and/or mixtures of base products to be used as the field products are determined for said particular part of the agricultural field, and the base products are filled into the field containers of the respective field device such that the field products in the field containers are the determined specific base products and/or mixtures of base products for the particular part of the agricultural field. Said particular part of the agricultural field may comprise one or more zones of the agricultural field. The particular part of the agricultural field may be chosen as a next part of a plurality of consecutive parts of the agricultural field. Alternatively, the particular parts may be chosen such that each of the particular parts comprises zones of the agricultural field with similar field data. In this case, the mixture can be determined such that it matches the requirements of the zones of the agricultural field even better.

According to another aspect of the invention, a modular agricultural treatment system is provided. The modular agricultural treatment system comprises a base station, at least one field device and a computing unit. The base station has at least three base containers, wherein each of the base containers is adapted to be filled with a base product. Each field device comprises at least two field containers that are adapted to be filled with a field product, and the field device is adapted to apply the field products to the agricultural field. The computing unit is adapted to determine, based on base product data and field data, base products and/or mixtures of base products to be used as the field products and a product composition made up out of the field products to be applied to zones of the agricultural field. The modular agricultural treatment system is adapted to perform the method according to the above description. Advantages and further embodiments of the modular agricultural treatment system correspond to those mentioned in the above description.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows a schematic side view of an embodiment of a modular agricultural treatment system;

FIG. 2 shows a schematic side view of another embodiment of a modular agricultural treatment system ; and

FIG. 3 shows a flow chart of a method for operating a modular agricultural treatment system.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

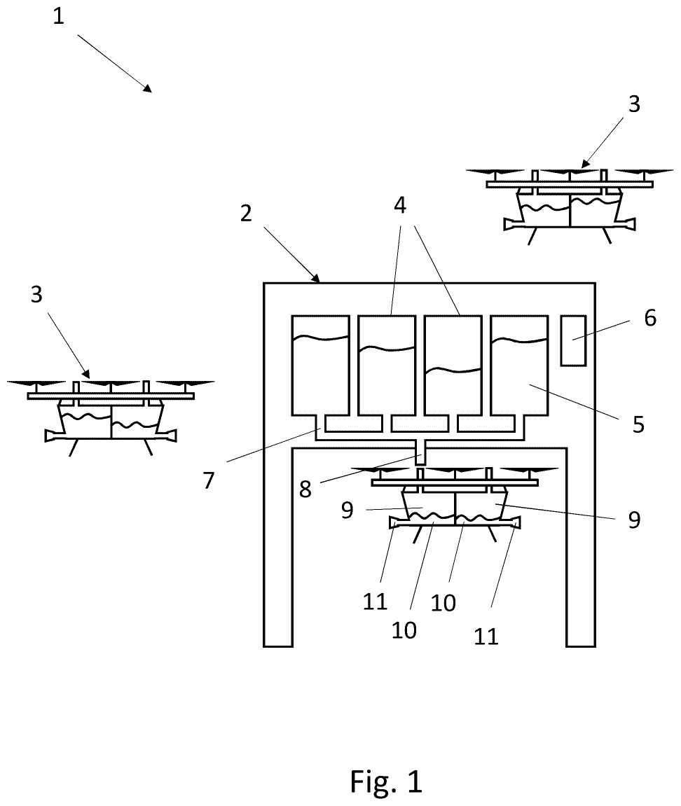

FIG. 1 shows a schematic side view of an embodiment of a modular agricultural treatment system 1. The modular agricultural treatment system 1 comprises a base station 2 and a plurality of unmanned aerial spraying systems (UASSs) 3, i.e., drones, as examples for field devices. Of course, the modular agricultural treatment system 1 may also comprise more than one base station 2 and the number of UASSs 3 may be greater than the three UASSs 3 shown in FIG. 1.

The base station 2 comprises at least three, in this example four, base containers 4 that are each filled with a base product 5. The base products 5 may be chemical products, biological products, fertilizers, nutrients, bio-stimulants, pheromones, water, tank-mix adjuvants, detergents, compatibilizers, anti-foaming agents, water conditioners and/or pH-modifiers, or mixtures thereof. While the sizes of the four base containers 4 are shown to be identical in FIG. 1, different sizes may be used, in particular related to the estimated need of the respective base products 5, e.g., the base container 4 containing water (for example used as a carrier for other base products 5) may be larger than the base container 4 containing a specific pheromone. The base station 2 further comprises a computing unit 6 that is adapted to determine base products 5 and/or mixtures of base products 5 to be used as field products and, for each of a plurality of zones of an agricultural field, a product composition made up out of the field products to be applied to the zone of the agricultural field. Pipes 7 are connected to each of the base containers 4 and converge in a filling pipe 8, i.e., the base products 5 from the base containers 4 may flow together in the filling pipe 8. Valves and/or pumps that control the flow of the base products 5, based on the base products 5 and/or mixtures of base products 5 to be used as the field products determined by the computing unit 6, are not shown to avoid clutter in the Figure.

The UASSs 3 each comprise two field containers 9 that are adapted to be filled with field products 10, wherein the field products 10 are base products 5 or mixtures of the base products 5. The UASSs 3 may comprise more than two field containers 9, but the number of field containers 9 per UASS 3 should be less than the number of base containers 4 in the base station 2. The UASSs 3 further comprise nozzles 11 such that they may apply the field products 10 to an agricultural field. In this embodiment, the nozzles 11 may be operated separately such that the product composition of the field products 10 that has been determined by the computing unit 6 is applied to the agricultural field.

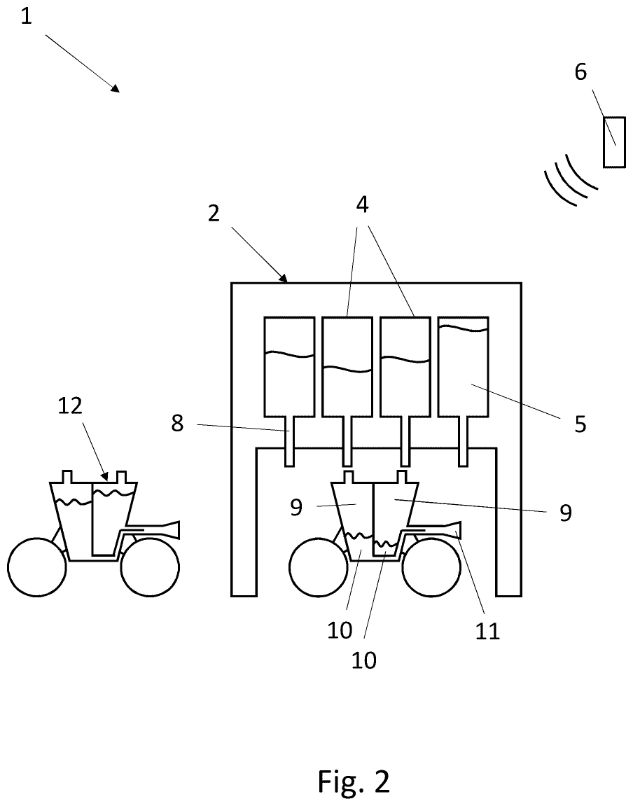

FIG. 2 shows a schematic side view of another embodiment of a modular agricultural treatment system 1. According to this embodiment, the base containers 4 are each equipped with a filling pipe 8 such that the base products 5 may be filled separately into the field containers 9 of the field device. The base products 5 and/or mixtures of the base products 5 to be used as field products 10 are, again, determined by a computing unit 6, which in this case is a remote computing unit 6. The computing unit 6 wirelessly transmits the determined base products 5 and/or mixtures of base products 5 to be used as field products 10 as well as determined product compositions made up out of the field products 10 to be applied to the zones of the agricultural field. A control unit (not shown) of the base station 2 receives said determined base products 5 and mixtures of base products 5 to be used as the field products 10 and controls the filling of the base products 5 into the field container 9 accordingly. The determined product compositions may be received by the base station 2 and then forwarded to the field devices or may be received directly by the field devices.

In this embodiment, the field devices are agricultural robots 12. They also comprise field containers 9 and nozzles 11 to apply the field products 10 to the agricultural field. In this embodiment, the field products 10 are mixed in a mixing chamber according to the determined product composition and are then applied through one nozzle 11.

The base station 2 may be kept stationary while the field devices 3 or 12 apply the field products 10 to the agricultural field. Also, the base station 2 may further supply power to the field devices 3 or 12 and/or may be adapted to clean the field devices 3 or 12. Also, the base station 2 may comprise a user interface or may be connected to a user interface that allows a user, e.g., a farmer, to input a desired effect. Said desired effect may comprise an intended crop rotation, previous crops and potentially relevant input factors, and/or a level of investment/intensity for the desired outcome.

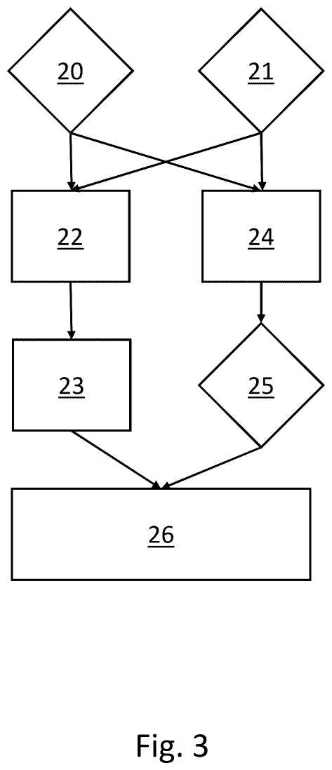

FIG. 3 shows a flowchart of a method for operating a modular agricultural treatment system 1. According to the method, base product data 20 relating to the base products 5 and field data 21 relating to field conditions on the agricultural field are provided. The base product data 20 may comprise active ingredient information, agricultural performance information, dosage form, viscosity, surface tension, turbidity, risk of phase separation, loading, physical compatibility data, chemical data, crop registration, health deficiency registration and/or mixture registration. The field data 21 may comprise general field conditions, crop type, crop growth stage, crop disease, disease prediction, pest pressure, pest prediction, weed pressure, weed prediction, crop infection risk, abiotic stress, temperature, humidity, precipitation, weather conditions, weather forecast, soil characteristics, time of application, previously applied products and/or product requirements.

Based on the base product data 20 and the field data 21, base products 5 and/or mixtures of base products 5 to be used as the field products 10 are determined 22. Said determination 22 may be performed by the computing 6 using a smart algorithm and/or an artificial intelligence system.

According to the determined 22 base products 5 and/or mixtures of base products 5, the base products 5 are filled 23 into the field containers 9 of the field device 3 or 12 such that the field products 10 in the field containers 9 are the determined base products 5 and/or mixtures of base products 5.

Also, based on the base product data 20 and the field data 21, for each of the plurality of zones of the agricultural field, a product composition 25 made up out of the field products 10 to be applied to the zone of the agricultural field is determined 24. Said determination 24 may also be performed by the computing unit 6 using a smart algorithm and/or an artificial intelligence system. In particular, the determination 24 may be performed together with the determination 22.

Finally, the field products 10 are applied 26 to the agricultural field according to the determined product composition 25.

When the above described method is used with the modular agricultural treatment system 1, an optimal product composition 25 of the base products 5 is applied to the agricultural field, wherein “optimal” may be a holistical response to all relevant conditions of the agricultural field. This may ensure an optimal input-output ratio, wherein the input refers particularly to the base products 5 used and the output refers to the agricultural effect, an increase in profitability and an avoidance of excessive use of products, without having to (re-)formulate existing products under changing conditions.

As a specific example, the control of phytophthora (late blight) in potatoes is discussed. The control of late blight requires typically multiple applications throughout the season. Besides tolerant varieties, farmers use protective and systemic products to prevent infection. Late blight is not only destroying the green leaves of the plants but can lead to latent infections on the newly formed tubers. Such tubers do not only cause problems in storage but can also be the starting point of new epidemics in a field. An effective disease development in a field needs mainly two factors to come together: favorable climatic conditions, mainly sufficient water, and inoculum which may come from infected tubers or from neighboring fields.

To optimize the control strategy, autonomously acting application systems can play a fundamental role in multiple areas: in remote sensing of infected plants or field zones from where the disease spread is initiated; in mapping of in-field climatic conditions leading to identifying higher risk zones where disease may be initiated more likely as, e.g., more humidity is available; in applying an optimal mixture of base products 5 at the different growth and disease stages, at an optimum timing and dosage, and at spray intervals defined by in-field conditions and not limited by labor availability.

According to the above described method, the “performance at target” is optimized by applying a product composition made up out of the at least two field products 10 on demand, according to disease situation, crop sanity status and particularly the in-field conditions at moment of application. The required dose may be adapted within the field or a sub-zone of the field.

Particularly, the following steps may be performed: field conditions such as soil, geography, microclimate, and/or soil moisture may be mapped before sowing. Smart algorithms may be used for defining risk zones within the field according to crop and late blight development needs. Growth and disease development may be monitored at short intervals, either physically or remotely using, e.g., drone, plane or satellite images or in-field sensors. The captured data may be processed and may be put in relation to historic information, risk zone mapping and to farmer s expectations. Smart algorithms may be used for deciding on the base products 5 and/or mixtures of base products 5 to be carried by the field devices 3 or 12 into the agricultural field allowing to generate an optimal product mixture given by the product composition 25 using an on-board direct-injection system. The quantity and spatial distribution of the combined active ingredients already applied and potentially to be applied may be factored in to prevent infringement of product approvals and regulatory requirements (e.g., buffer zones to sensitive areas, re-entry and pre-harvest intervals), to foster sustainability aspects, for resistance management and for staying in line with farmer's expectations. The field containers 9 may be autonomously filled by the base station 2. The optimal mixture may then be generated using the field products 10. If necessary, multiple flights of the UASSs 3 may be initiated to complete the task. Quality assessment may be performed by measuring the effect on disease and crop development by either physical inspection or remote sensing using, e.g., drone, plane or satellite images. An automatic feedback of the base station 2 may be provided in case a base product 5 shortage is expected. The base products 5 may be re-filled or the empty base containers 4 may be replaced. All activities may be recording of and relevant information may be delivered directly into a farm documentation system.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for operating a modular agricultural treatment system useable for treating a harmful organism and/or a plant health deficiency on an agricultural field,
wherein the modular agricultural treatment system comprises:
a base station with at least three base containers, wherein each of the base containers is filled with a base product and
at least one field device each field device comprising at least two field containers, wherein each field container is adapted to be filled with a field product, and wherein the field device is adapted to apply the field products to the agricultural field;
and the method comprises:
providing base product data relating to the base products;
providing field data relating to field conditions on the agricultural field;
determining, based on the base product data and the field data, base products and/or mixtures of base products to be used as the field products;
filling the base products into the field containers of the field device such that the field products in the field containers are the determined field products;
determining, based on the base product data and the field data for each of a plurality of zones of the agricultural field, a product composition made up out of the field products to be applied to the zone of the agricultural field; and
applying the field products to the zones of the agricultural field by the field device according to the determined product composition.

2. The method according to claim 1, wherein the base products are at least one out of a group or a mixture of at least two out of the group, the group consisting of chemical products, biological products, fertilizers, nutrients, bio-stimulants, pheromones, water, tank-mix adjuvants, detergents, compatibilizers, anti-foaming agents, water conditioners and pH-modifiers.

3. The method according to claim 1, wherein the base station further performs supplying power to the field device and/or cleaning the field device.

4. The method according to claim 1, wherein the field device is an agricultural robot and/or an unmanned aerial spraying system.

5. The method according to claim 1, wherein the field data comprises at least one out of general field conditions, crop type, crop growth stage, crop disease, disease prediction, pest pressure, pest prediction, weed pressure, weed prediction, crop infection risk, abiotic stress, temperature, humidity, precipitation, weather conditions, weather forecast, soil characteristics, time of application, previously applied products and/or product requirements.

6. The method according to claim 1, wherein at least some of the field data is taken in short intervals, the short intervals being one week or less, and/or a short time span before applying the field products the short time span being six hours or less.

7. The method according to claim 1, wherein determining the base products and/or mixtures of base products to be used as the field products and/or determining the product compositions to be applied to the zones of the agricultural field is performed by a smart algorithm and/or an artificial intelligence system.

8. The method according to claim 1, wherein
determining the product compositions to be applied to the zones of the agricultural field comprises generating an application map; and
applying the field products to the zones of the agricultural field according to the determined product composition comprises reading the determined product composition at the current location of the field device from the application map.

9. The method according to claim 1, wherein determining the product compositions to be applied to the zones of the agricultural field is further based on current field data obtained by the field device during the application of the field product.

10. The method according to claim 1, wherein the determined product composition is achieved by mixing the field products in particular with an on-board direct injection system of the field device

11. The method according to claim 1, wherein the determined product composition is achieved by separately applying the field products, at rates corresponding to the determined product composition.

12. The method according to claim 1, wherein
the method further comprises obtaining a desired effect as user input; and
the determination of the base products and/or mixtures of base products to be used as the field products and/or the determination of the product compositions to be applied to the zones of the agricultural field is further based on the desired effect.

13. The method according to claim 1, wherein
the method further comprises determining a time of application; and
the field products are applied to the agricultural field at the determined time of application.

14. The method according to claim 1, wherein
when a field device is scheduled to treat a particular part of the agricultural field, specific base products and/or mixtures of base products to be used as the field products are determined for said particular part of the agricultural field; and the base products are filled into the field containers of the respective field device such that the field products in the field containers are the determined specific base products and/or mixtures of base products for the particular part of the agricultural field.

15. A modular agricultural treatment system, comprising
a base station with at least three base containers, wherein each of the base containers is adapted to be filled with a base product;
at least one field device wherein each field device comprises at least two field containers, wherein each field container is adapted to be filled with a field product, and the field device is adapted to apply the field products to the agricultural field; and
a computing unit, adapted to determine, based on base product data and field data base products and/or mixtures of base products to be used as the field products and a product composition made up out of the field products to be applied to zones of the agricultural field;
wherein the modular agricultural treatment system is adapted to perform the method according to claim 1.
